(19) United States
(12) Patent Application Publication
(10) Pub. No.: US 2016/0160710 A1
(43) Pub. Date: Jun. 9, 2016

(54) ENGINE BRAKING VIA ADVANCING THE EXHAUST VALVE

(71) Applicant: BORGWARNER INC., Auburn Hills, MI (US)

(72) Inventors: David B. ROTH, Groton, NY (US); Philip S. KELLER, Clarkston, MI (US); Volker JOERGL, Breitenfurt (AT)

(21) Appl. No.: 14/900,878

(22) PCT Filed: Jun. 25, 2014
(86) PCT No.: PCT/US14/44009

§ 371 Date: Dec. 22, 2015

Related U.S. Application Data
(60) Provisional application No. 61/842,619, filed on Jul. 3, 2013.

(51) Int. Cl. F01L 13/06; F02D 13/04; F01L 9/04; F02D 13/02; F01L 1/344; F01L 1/047

(52) U.S. Cl. CPC F01L 13/06; F01L 1/344; F01L 1/047; F01L 9/04; F02D 13/0246; F02D 13/04; F01L 2009/0421

(57) ABSTRACT

One variation may include a product including: an engine having at least one cylinder, the cylinder having at least one blowdown exhaust valve, at least one scavenging exhaust valve, and at least one intake valve, the engine further having a first actuator connected to the at least one blowdown exhaust valve and a second actuator connected to the scavenging exhaust valve and controller connected to one of the first or second actuator and adapted and configured to advance the timing of one of the blowdown or scavenging exhaust valves when the controller receives a braking signal.

### CROSS-REFERENCE TO RELATED APPLICATIONS

This application claims the benefit of the filing date of U.S. Provisional Application No. 61/842,619 filed Jul. 3, 2013.

### TECHNICAL FIELD

The technical field generally relates to diesel engine braking.

### BACKGROUND

Engine braking may be used in vehicles.

### SUMMARY OF SOME ILLUSTRATIVE VARIATIONS OF THE INVENTION

One variation of the invention may include a product having an engine having at least one cylinder. The cylinder may have at least one blowdown exhaust valve, at least one scavenging exhaust valve, and at least one intake valve. The engine may further have a first actuator connected to the at least one blowdown exhaust valve and a second actuator connected to the scavenging exhaust valve. The product may also include a controller connected to one of the first or second actuator and adapted and configured to advance the timing of one of the blowdown or scavenging exhaust valves when the controller receives a braking signal.

Another variation of the invention may include a product for providing engine braking of an engine having at least one cylinder. The at least one cylinder may have at least one exhaust valve connected to a variable valve timing mechanism. The product may comprise a controller connected to the variable valve timing mechanism and adapted and configured to advance the timing of the exhaust valve when the controller receives a braking signal.

Yet another variation of the invention may include method of generating engine braking for an engine having at least one cylinder with at least one exhaust valve. The method may comprise advancing the timing of the exhaust valve.

Yet another variation of the invention may include method of providing engine braking which includes an engine with multiple cylinders, each cylinder having blowdown exhaust valves and scavenging exhaust valves, the blowdown exhaust valve being actuatable by blowdown exhaust valve actuator and the scavenging exhaust valve being acuatable by a scavenging exhaust valve actuator and a controller connected to the actuators and configured to receive a braking signal, the method comprising signaling one of blowdown exhaust valve actuator or the scavenging exhaust valve actuator to advance the timing of the associated blowdown or scavenging exhaust valve signaling one of blowdown exhaust valve actuator or the scavenging exhaust valve actuator to advance the timing of the associated blowdown or scavenging exhaust valve.

Other variations of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Variations of the present disclosure will become more fully understood from the detailed description and the accompanying drawings, wherein:

FIG. 1 is a Pressure vs. Volume graph for an exhaust flap engine braking system.

FIG. 2 is a Brake Power vs. Engine Speed graph for an Exhaust flap engine braking system.

FIG. 3 is a Pressure vs. Volume graph for a CRB engine braking system.

FIG. 4 is a Brake Power vs. Engine Speed graph for a CRB engine braking system.

FIG. 5 is a schematic of an internal combustion engine according to a variation of the invention.

FIG. 6 is a schematic of an internal combustion engine valvetrain according to a variation of the invention.

FIG. 7 is a schematic of an internal combustion engine valvetrain according to a variation of the invention.

FIG. 8 is a schematic of an internal combustion engine valvetrain according to a variation of the invention.

FIG. 9 is a schematic of an internal combustion engine valvetrain according to a variation of the invention.

FIG. 10 is a schematic of internal combustion engine valvetrain according to a variation of the invention.

FIG. 11 is a schematic of a variable valve timing mechanism according to a variation of the invention.

FIG. 12a is a flow chart of a variation of a method of providing engine braking.

FIG. 12b is a flow chart of another variation of a method of providing engine braking.

FIG. 13 is a Lift vs. Angle chart for a phased engine braking system according to a variation of the invention.

FIG. 14 is a Pressure vs. Volume chart for a phased engine braking system according to a variation of the invention.

FIG. 15 is a Lift vs. Angle chart for a multi phased engine braking system according to a variation of the invention.

FIG. 16 is a Pressure vs. Volume chart for a multi phased engine braking system according to a variation of the invention.

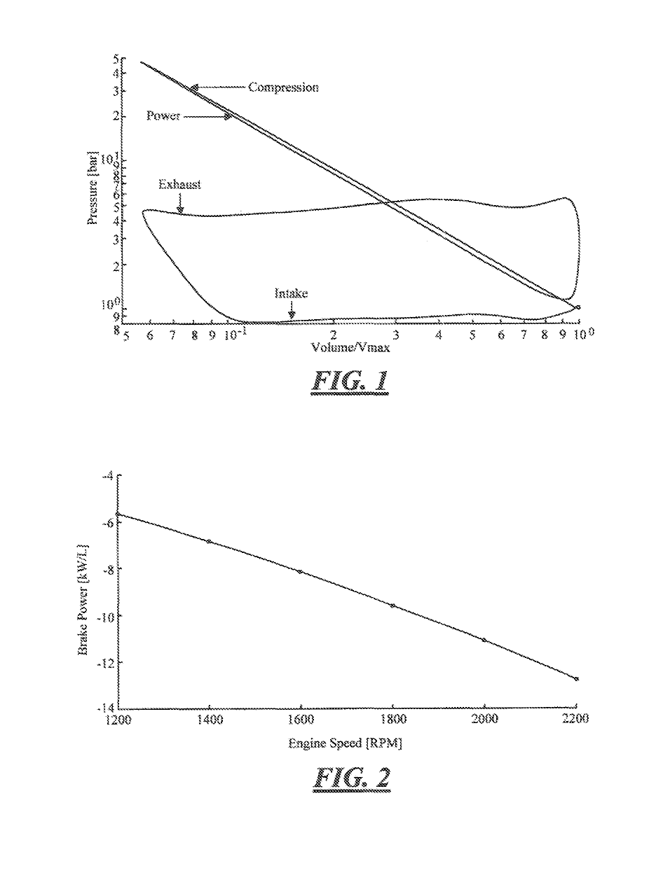

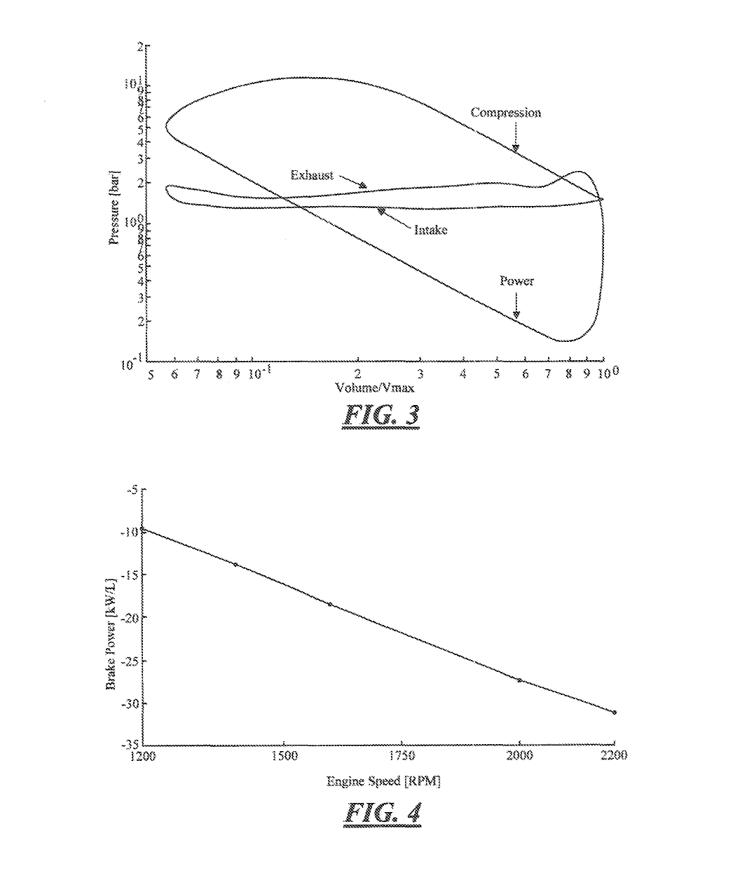

### DETAILED DESCRIPTION OF SOME ILLUSTRATIVE VARIATIONS

The following description of some variations of the invention is merely illustrative in nature and is in no way intended to limit the invention, its application, or its uses.

The figures illustrate numerous variations of an internal combustion engine valve train 10 that may be equipped in an internal combustion engine 12 constructed and designed for divided exhaust gas flow—that is, blowdown and scavenge exhaust gas flow in order to provide engine braking. In at least some of the variations, the internal combustion engine valvetrain 10 may provide independent control over the actuation of intake valves 14, blowdown exhaust valves 16, scavenge exhaust valves 18, or a combination thereof. In some variations, providing independent control over the actuation of the different valves 14, 16, 18 of the internal combustion engine 12 facilitates optimization of engine operation including, for example, increasing engine power and improving engine efficiency.

FIG. 5 illustrates a number of variations, which may include an internal combustion engine (ICE) 12 may combust fuel with an oxidizer (e.g., air) and may expel fluid, such as exhaust gas which may include gas, liquid, and other matter, thereafter to an ICE breathing system (not shown). The ICE 12 may be a spark-ignited engine (e.g., gasoline, methanol), a diesel engine, an alternative fuel engine, or another type. The ICE 12 may be of different types having different arrangements and different numbers of cylinders (i.e., in-line, I-2, I-4, I-6, V-type, V-6, V-8, etc.). A cylinder block may sit below a cylinder head and may have cylindrical bores that accommodate reciprocating pistons. The ICE 12 may function under a four-stroke engine operating cycle with what-is-called a divided exhaust gas flow having a blowdown exhaust phase and a scavenging exhaust phase. In the blowdown exhaust phase, the blowdown exhaust valves 16 may open just before the associated piston reaches a bottom dead center (BDC) position. Exhaust gas then enters blowdown exhaust ports 20 under relatively increased pressure. In the scavenging exhaust phase, the scavenge exhaust valves 18 may open as the associated piston sweeps back up from the BDC position and toward a top dead center (TDC) position to displace most, if not all, of the remaining exhaust gas. The remaining exhaust gas then enters scavenge exhaust ports 22 under a comparatively decreased pressure. In some variations, an intake manifold, exhaust manifold, or both, may be provided for the ICE 12; the exhaust manifold may include a blowdown exhaust manifold and a scavenge exhaust manifold, which may be provided as separate components or as a one-piece component.

Referring again to FIG. 5, the ICE 12 may include a cylinder head 24 which, in the example shown, may include four cylinders 26 arranged in-line. Each cylinder 26 may have a pair of the intake valves 14 that communicate with an intake port 28, a single blowdown exhaust valve 16, and a single scavenge exhaust valve 18. In other variations, the blowdown exhaust ports 20, the scavenge exhaust port 22, or both, may converge toward each other into a single and common port(s) before exiting the body of the cylinder head 24.

Downstream of the blowdown and scavenge exhaust ports 20, 22, an internal combustion engine breathing system may include, among other components, a pair of turbochargers, an exhaust gas after treatment device, one or more exhaust gas recirculation (EGR) subsystems or assemblies, and a charge-air cooler.

FIGS. 6-10 schematically show several variations of the internal combustion engine valvetrain 10. In all of the variations shown in FIGS. 6-10, the blowdown exhaust valves 16 and the scavenge exhaust valves 18 are independently operated and controlled via separate and distinct valve actuation mechanisms. The figures are schematic and are not necessarily meant to show specific arrangements and constructions of the valves and the valve actuation mechanisms—for example, the exact locations of the valves in application with respect to one another may be different than what is shown in FIGS. 6-10. The valve actuation mechanisms separately and distinctly open and close the blowdown exhaust valves 16 and the scavenge exhaust valves 18 independent of one another. In some variations, this may mean that the blowdown exhaust valves 16 and the scavenge exhaust valves 18 do not derive their opening and closing movements via a single and the same camshaft. This may also mean that one camshaft physically causes the opening and closing of the blowdown exhaust valve and not the scavenge exhaust valve, and another camshaft physically causes the opening and closing of the scavenge exhaust valve and not the blowdown exhaust valve. In some cases, providing separate and distinct opening and closing functionality of the blowdown exhaust valves 16 and the scavenge exhaust valves 18 may provide versatile engine operation which may facilitate optimization of engine performance including, for example, increased engine power and improved engine efficiency. In the variations illustrated by FIG. 6, the intake valve 14, the blowdown exhaust valve 16, and the scavenge exhaust valve 18 may include a poppet valve 30 that may reciprocate linearly up-and-down in a combustion chamber 32 against and with the biasing force of a spring 34. Other constructions, arrangements, and components of the valves are possible. A first valve actuation mechanism 36 may be constructed and arranged to open and close both the intake valve 14 and the blowdown exhaust valve 16, and a second valve actuation mechanism 38 may be constructed and arranged to open and close the scavenge exhaust valve 18 separately, distinctly, and independently of the intake and blowdown exhaust valves. The first valve actuation mechanism 36 may be what-is-known-as a type three, and may include a first camshaft 40 having numerous lobes 42, and may also include a first rocker arm 44 and a second rocker arm 46. In use, the first camshaft 40 may rotate and spin while the lobes 42 impinge upon the first and second rocker arms 44, 46 which may then themselves move about their respective pivot and impinge upon the poppet valves 30 of the intake and blowdown exhaust valves 14, 16. In response, the poppet valves 30 may be opened and closed. Different lobes 42 may impinge upon the first and second rocker arms 44, 46 at different degrees of angular rotation of the first camshaft 40, which may cause the intake and blowdown exhaust valves 14, 16 to actuate at different times, and may cause the intake and blowdown exhaust valves to have different characteristics with respect to each other such as different timing and lift.

Furthermore, the second valve actuation mechanism 38 may be what-is-known-as a type one, and may include a second camshaft 48 having numerous lobes 50. In use, the second camshaft 48 may rotate and spin while the lobes 50 may directly impinge upon the poppet valve 30 of the scavenge exhaust valve 18, which may cause the poppet valve of the scavenge exhaust valve to open and close.

Still referring to the variations illustrated by FIG. 6, a variable valve timing mechanism 52 may be operatively equipped to the second camshaft 48 in order to continuously control actuation of the scavenge exhaust valve 18. In one variation, the variable valve timing mechanism 52 may be a variable camshaft phaser that may control event-phasing. Event phasing describes a way of advancing or retarding a valve's actuation phase (measured in crank angle degrees, from when a valve opens to when it closes) with respect to a piston stroke relative to a top-dead-center position. Operation of the variable valve timing mechanism 52 may be commanded from an associated engine control unit or module. And in one variation, the variable valve timing mechanism 52 may include, among other components, a variable force solenoid and a spool valve. In other variations, the variable valve timing mechanism may be of different types; may have different constructions; may have more, less, and/or different components; and may have different arrangements. Furthermore, though not shown, a separate and distinct variable valve timing mechanism may be operatively equipped to the first camshaft 40 in order to continuously control actuation of the intake and blowdown exhaust valves 14, 16. In one variation, the variable valve timing mechanism for the first camshaft 40 may be a variable camshaft phaser as described immediately above.

In the variations described above, the blowdown exhaust valve 16, the scavenge exhaust valve 18, or both, may be controlled—phases advanced, retarded, or both as is known in the art. Exhaust gas may be delivered to the associated turbochargers in a selective way to control turbocharger boost; in some variations, a turbine bypass for the turbochargers may be eliminated. Also, using that control method, or using another suitable control method, exhaust gas may be delivered to the associated EGR subsystem in a selective way to improve engine operation. In one example, when both the first camshaft 40 and the second camshaft 48 are equipped with a variable valve timing mechanism such as the variable valve timing mechanisms described above, the valves 14, 16, 18 may be controlled in order to optimize engine power at heavy-load engine operation conditions and in order to optimize engine efficiency at light-to-moderate-load engine operating conditions.

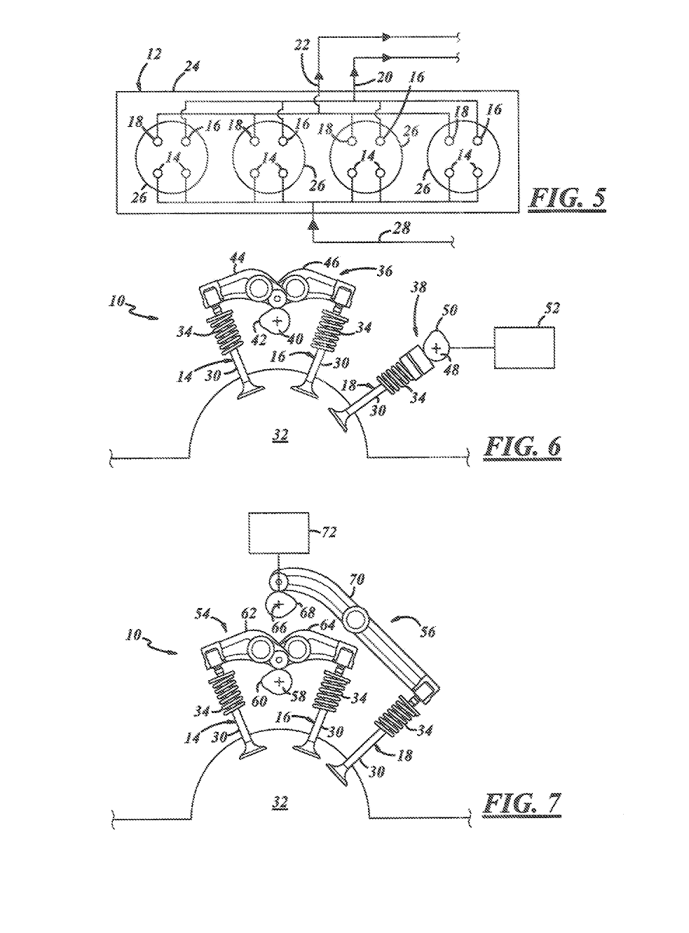

In the variations illustrated by FIG. 7, a first valve actuation mechanism 54 may be constructed and arranged to open and close both the intake valve 14 and the blowdown exhaust valve 16, and a second valve actuation mechanism 56 may be constructed and arranged to open and close the scavenge exhaust valve 18 separately, distinctly, and independently of the intake and blowdown exhaust valves. The first valve actuation mechanism 54 may be what-is-known-as a type three, and may include a first camshaft 58 having numerous lobes 60, and may also include a first rocker arm 62 and a second rocker arm 64. General use and functionality of this type of valve actuation mechanism has been previously described. Likewise, the second valve actuation mechanism 56 may be what-is-known-as a type three, and may include a second camshaft 66 having numerous lobes 68, and may also include a third rocker arm 70. Again, general use and functionality of this type of valve actuation mechanism has been previously described. Still referring to FIG. 7, a variable valve timing mechanism 72 may be operatively equipped to the second camshaft 66 in order to continuously control actuation of the scavenge exhaust valve 18. In one variation, the variable valve timing mechanism 72 may be a variable camshaft phaser, as previously described. In other variations, the variable valve timing mechanism may be of different types; may have different constructions; may have more, less, and/or different components; and may have different arrangements. Furthermore, though not shown, a separate and distinct variable valve timing mechanism may be operatively equipped to the first camshaft 58 in order to continuously control actuation of the intake and blowdown exhaust valves 14, 16. In one variation, the variable valve timing mechanism for the first camshaft 58 may be a variable camshaft phaser, as previously described. Also, in the variations illustrated by FIG. 7, the variable valve timing mechanisms may be controlled according to the methodology described in relation to the variation of FIG. 6.

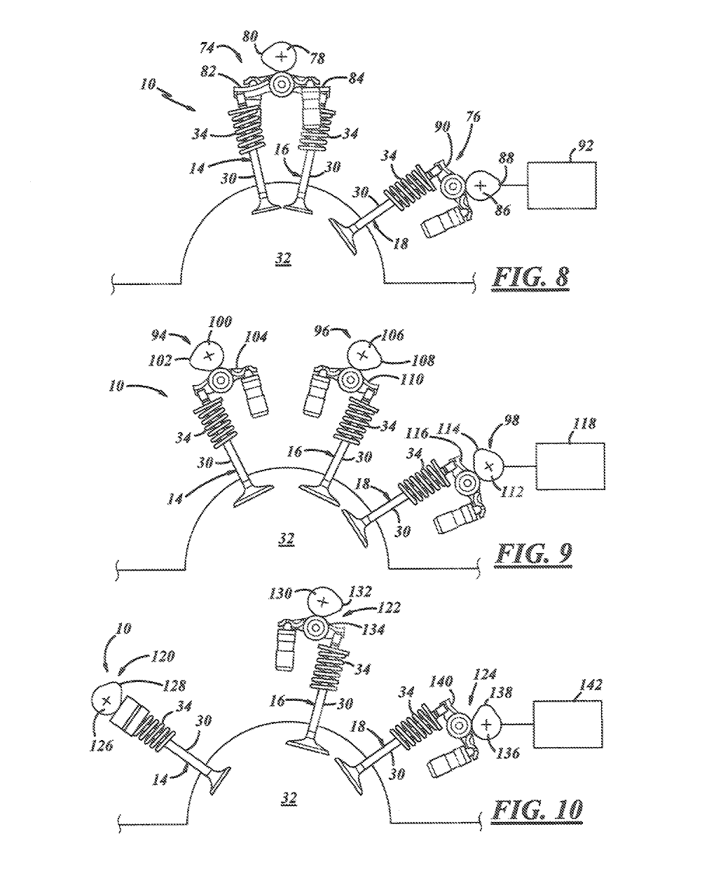

In the variations illustrated by FIG. 8, a first valve actuation mechanism 74 may be constructed and arranged to open and close both the intake valve 14 and the blowdown exhaust valve 16, and a second valve actuation mechanism 76 may be constructed and arranged to open and close the scavenge exhaust valves 18 separately, distinctly, and independently of the intake and blowdown exhaust valves. The first valve actuation mechanism 74 may be what-is-known-as a type two, and may include a first camshaft 78 having numerous lobes 80, and may also include a first rocker arm 82 and a second rocker arm 84. In use, the first camshaft 78 may rotate and spin while the lobes 80 impinge upon the first and second rocker arms 82, 84 which may then themselves move about their respective pivot and impinge upon the poppet valves 30 of the intake and blowdown exhaust valves 14, 16. Likewise, the second valve actuation mechanism 76 may be what-is-known-as a type two, and may include a second camshaft 86 having numerous lobes 88, and may also include a third rocker arm 90. General use and functionality of this type of valve actuation mechanism has been previously described. Still referring to FIG. 8, a variable valve timing mechanism 92 may be operatively equipped to the second camshaft 86 in order to continuously control actuation of the scavenge exhaust valve 18. In one variation, the variable valve timing mechanism 92 may be a variable camshaft phaser, as previously described. In other variations, the variable valve timing mechanism may be of different types; may have different constructions; may have more, less, and/or different components; and may have different arrangements. Furthermore, though not shown, a separate and distinct variable valve timing mechanism may be operatively equipped to the first camshaft 78 in order to continuously control actuation of the intake and blowdown exhaust valves 14, 16. In one variation, the variable valve timing mechanism for the first camshaft 78 may be a variable camshaft phaser, as previously described. Also, in the variations illustrated by FIG. 8, the variable valve timing mechanisms may be controlled according to the methodology described in relation to the variation of FIG. 6.

In the variations illustrated by FIG. 9, a first valve actuation mechanism 94 may be constructed and arranged to open and close the intake valve 14, a second valve actuation mechanism 96 may be constructed and arranged to open and close the blowdown exhaust valve 16, and a third valve actuation mechanism 98 may be constructed and arranged to open and close the scavenge exhaust valve 18. The first, second, and third valve actuation mechanisms 94, 96, 98 may actuate their respective valve separately, distinctly, and independently of the other two valves. The first valve actuation mechanism 94 may be what-is-known-as a type two, and may include a first camshaft 100 having numerous lobes 102, and may also include a first rocker arm 104. General use and functionality of this type of valve actuation mechanism has been previously described. Likewise, the second valve actuation mechanism 96 may be what-is-known-as a type two, and may include a second camshaft 106 having numerous lobes 108, and may also include a second rocker arm 110. General use and functionality of this type of valve actuation mechanism has been previously described. And similarly, the third valve actuation mechanism 98 may be what-is-known-as a type two, and may include a third camshaft 112 having numerous lobes 114, and may also include a third rocker arm 116. General use and functionality of this type of valve actuation mechanism has been previously described.

Still referring to FIG. 9, a variable valve timing mechanism 118 may be operatively equipped to the third camshaft 112 in order to continuously control actuation of the scavenge exhaust valve 18. In one variation, the variable valve timing mechanism 118 may be a variable camshaft phaser, as previously described. In other variations, the variable valve timing mechanism may be of different types; may have different constructions; may have more, less, and/or different components; and may have different arrangements. Furthermore, though not shown, a separate and distinct variable valve timing mechanism may be operatively equipped to the first camshaft 100 in order to continuously control actuation of the intake valve 14. In one variation, the variable valve timing mechanism for the first camshaft 100 may be a variable camshaft phaser, as previously described. Furthermore, though not shown, a separate and distinct variable valve timing mechanism may be operatively equipped to the second camshaft 106 in order to continuously control actuation of the blowdown exhaust valve 16. In one variation, the variable valve timing mechanism for the second camshaft 106 may be a variable camshaft phaser, as previously described. Also, in the variation of FIG. 9, the variable valve timing mechanisms may be controlled according to the methodology described in relation to the variations illustrated by FIG. 6.

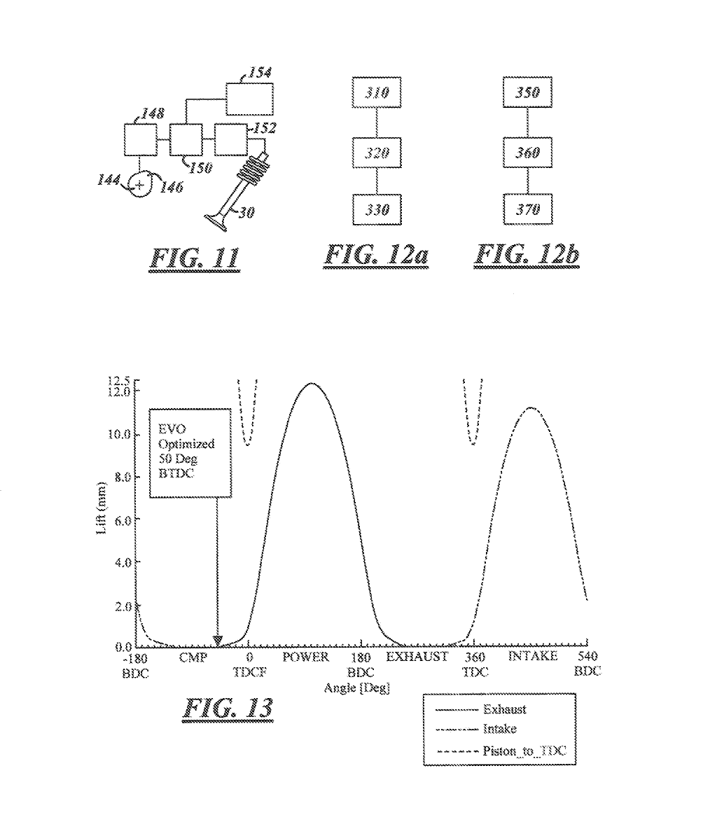

In the variations illustrated by FIG. 10, a first valve actuation mechanism 120 may be constructed and arranged to open and close the intake valve 14, a second valve actuation mechanism 122 may be constructed and arranged to open and close the blowdown exhaust valve 16, and a third valve actuation mechanism 124 may be constructed and arranged to open and close the scavenge exhaust valve 18. The first, second, and third valve actuation mechanisms 120, 122, 124 may actuate their respective valve separately, distinctly, and independently of the other two valves. The first valve actuation mechanism 120 may be what-is-known-as a type one, and may include a first camshaft 126 having numerous lobes 128. General use and functionality of this type of valve actuation mechanism has been previously described. The second valve actuation mechanism 122, on the other hand, may be what-is-known-as a type two, and may include a second camshaft 130 having numerous lobes 132, and may also include a second rocker arm 134. General use and functionality of this type of valve actuation mechanism has been previously described. And similarly, the third valve actuation mechanism 124 may be what-is-known-as a type two, and may include a third camshaft 136 having numerous lobes 138, and may also include a third rocker arm 140. General use and functionality of this type of valve actuation mechanism has been previously described.

Still referring to FIG. 10, a variable valve timing mechanism 142 may be operatively equipped to the third camshaft 136 in order to continuously control actuation of the scavenge exhaust valve 18. In one variation, the variable valve timing mechanism 142 may be a variable camshaft phaser, as previously described. In other variations, the variable valve timing mechanism may be of different types; may have different constructions; may have more, less, and/or different components; and may have different arrangements. Furthermore, though not shown, a separate and distinct variable valve timing mechanism may be operatively equipped to the first camshaft 126 in order to continuously control actuation of the intake valve 14. In one variation, the variable valve timing mechanism for the first camshaft 126 may be a variable camshaft phaser, as previously described. Furthermore, though not shown, a separate and distinct variable valve timing mechanism may be operatively equipped to the second camshaft 130 in order to continuously control actuation of the blowdown exhaust valve 16. In one variation, the variable valve timing mechanism for the second camshaft 130 may be a variable camshaft phaser, as previously described. Also, in the variations illustrated by FIG. 10, the variable valve timing mechanisms may be controlled according to the methodology described in relation to the variations illustrated by FIG. 6.

The internal combustion engine valvetrain 10 may have other variations that are not shown in the figures. For example, in one variation, a first valve actuation mechanism may be constructed and arranged to open and close both the intake valve and the blowdown exhaust valve, and a second valve actuation mechanism may be constructed and arranged to open and close the scavenge exhaust valve separately, distinctly, and independently of the intake and blowdown exhaust valves. The first valve actuation mechanism may be what-is-known-as a type three, as previously described; and the second valve actuation mechanism may be what-is-known-as a type two, as previously described. In this variation, the second valve actuation mechanism may be equipped with variable valve timing functionality such as a variable camshaft phaser, as previously described. Further, the first valve actuation mechanism may be equipped with variable valve timing functionality such as a variable camshaft phaser, as previously described. And, in this variation, the variable valve timing functionality may be according to the methodology described in relation to the variations illustrated by FIG. 6.

In another variation not shown in the figures, a first valve actuation mechanism may be a first camless valve actuation mechanism and may be constructed and arranged to open and close the intake valve, and a second valve actuation mechanism may be a second camless valve actuation mechanism and may be constructed and arranged to open and close the scavenge exhaust valve. In an example camless valve actuation mechanism, individual actuators may be equipped at each individual poppet valve, and may be electromagnetically controlled, hydraulically controlled, pneumatically controlled, a combination thereof, or controlled another way. In this variation, a third valve actuation mechanism may be constructed and arranged to open and close the blowdown exhaust valve. The third valve actuation mechanism may include a camshaft having numerous lobes, and may be what-is-known-as a type one, type two, or type three, as all previously described. The first, second, and third valve actuation mechanisms may actuate their respective valve separately, distinctly, and independently of the other two valves. Further, in this variation, the third valve actuation mechanism may be equipped with variable valve timing functionality such as a variable camshaft phaser, as previously described. The variable valve timing functionality may be according to the methodology described in relation to the variations illustrated by FIG. 6.

Still in other variations not shown in the figures, the valve actuation mechanisms of the variations illustrated in FIGS. 6-10 may be constructed and arranged to constitute what-is-known-as a type four. For example, in the variations illustrated by FIG. 9, the first valve actuation mechanism 94 may be a type four, and may include a camshaft having numerous lobes, a rocker arm, and a lifter; in other examples, the type four may include other components and/or different components.

In further variations not shown in the figures, variations similar to those illustrated in FIGS. 6-10 with two camshafts that are separate and distinct from one another may include valve actuation mechanisms of any combination of the what-are-known-as types one, two, three, and four. For example, one variation may include a type one and a type two; another variation may include a type three and a type four; another variation may include a type two and a type four; and other examples exist. In further variations not shown in the figures, variations similar to those illustrated in

FIGS. 9 and 10 with three camshafts that are separate and distinct from one another may include valve actuation mechanisms of any combination of the what-are-known-as types one, two, three, and four. For example, one variation may include a first type three, a second type three, and a type two; another variation may include a type one, a type three, and a type four; another variation may include a first type one, a second type one, and a type three; and other examples exist.

In other variations, the valve actuation mechanisms of the variations illustrated in FIGS. 5-10 and other variations not shown may be operatively equipped with variable valve timing functionality such as what-is-commonly called multiair variable valve timing, or what-is-commonly called uniair variable valve timing. Referring to FIG. 9, in one example, a camshaft 144 having numerous lobes 146 may impinge upon a cam follower 148 such as a roller rocker arm or a piston. The cam follower 148 may communicate with an oil chamber 150 which may cause a hydraulic valve actuation mechanism 152 to open and close the respective poppet valve 30. A solenoid valve 154, which may be commanded via an associated engine control unit or module, may interact with the oil chamber 150 in order to vary valve timing and lift. In other examples, these variable valve timing functionalities may include more, less, or different components than shown and described here.

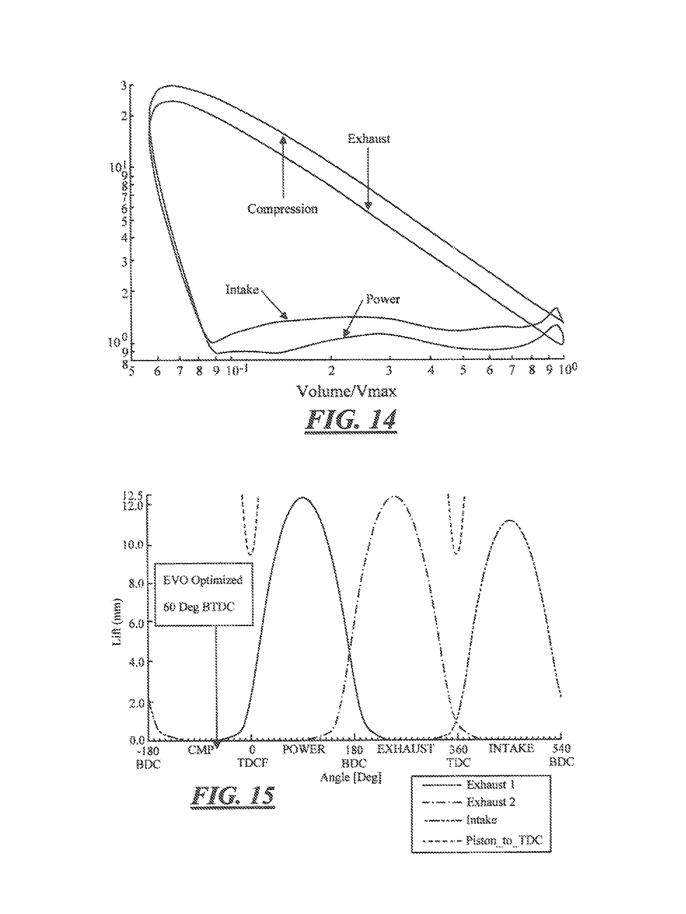

One variation of a control method will now be described with reference to FIGS. 12-18. In general, optimal valve timing of blowdown and scavenging valves 24, 25 will be application specific and, thus, will vary from engine to engine. But the blowdown valves 24 may have relatively advanced timing, have longer valve opening duration, with higher lift than the scavenging valves 25. In one example, the lift of the blowdown valves may be the maximum lift attainable in approximately 180 degrees of crank angle, and the lift of the scavenging valves may be the maximum lift attainable in approximately 160 degrees of crank angle.

Using a variable valve timing system, both the blowdown and scavenging exhaust valves 24, 25 may be phased or advanced. To provide optimal results, compressed gases should be released close to firing TDC but enough vacuum should be maintained in the cylinder during the expansion stroke so that the expansion work is negative. Preferably, the exhaust valves are opened close to TDC such that the maximum opening lies in the middle of the expansion stroke as shown in FIG. 13. In the modeled system, the optimum exhaust valve timing is 40-60, and preferably 50 crank degrees before firing TDC.

The phasing or advancing of the valve timing may be initiated when the controller receives a braking signal. The braking signal may originate from a variety of means such as when a driver of the vehicle depresses a brake pedal. Alternatively, the signal may originate from the driver by other means such as depressing a button or activating a switch. The braking signal may also originate automatically upon certain predetermined conditions such as imminent collision. The braking signal may also be originated remotely in driverless systems. As long as a signal to phase or advance the timing of the valves in generated, the exact process is not critical to this invention.

Alternatively, the cylinder may consist of a single exhaust valve, two exhaust valves, or any other number or combination of exhaust valves that may be advanced or phased to provide engine braking.

Phasing the exhaust valves in this way changes the engine cycle, especially the expansion and exhaust strokes as illustrated in FIG. 13. However, negative expansion work is hard to obtain like this because when the actual expansion stroke starts, the vacuum in the cylinder makes the exhaust valve act as a breathing device. There is a higher pressure in the exhaust manifold created due to the compression event which cause back flow of exhaust from manifold to cylinder during the expansion stroke. This in turn increases the trapped cylinder air mass and decreases the negative expansion work. This system achieves performance levels between the exhaust flap engine braking system and the CRB engine braking system.

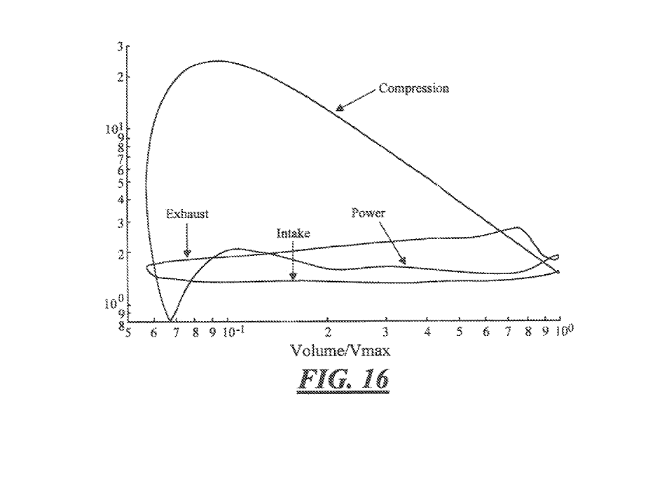

In a multi phased technique, having separate mechanism to phase the scavenging and blowdown exhaust valves 24, 25 independently allows for greater freedom which may be used advantageously to increase engine braking. To obtain the best results, the cylinder should be emptied at the end of the compression stroke and maintain minimal cylinder mass or vacuum condition during the expansion stroke to achieve high braking power. As illustrated in FIG. 15, one exhaust valve (either scavenging valve or blowdown valve) is opened during the expansion stroke while the timing of the other exhaust valve remains unchanged. This method was able to achieve results comparable with the CRB without an additional valve. The difference is that in the phased technique, the exhaust phase was eliminated completely while in this method the exhaust phase remained unchanged. The phased technique was able to blow all the gases out of the cylinder during the end of the compression stroke providing one braking event per four engine strokes. In contrast, this multiple phase technique was able to blow the exhaust gases out of the cylinder twice providing two braking events per four engine strokes. FIG. 16 depicts the pressure vs. volume chart for this multiple phase technique.

While the system is sensitive to different inputs and different configurations and will have different “optimal” timing requirements, the modeled system performed best at approximately 60 crank degrees BTDC as shown in FIG. 15.

Referring now to 12a, a variation of a method of generating engine braking for an engine having at least one cylinder with at least one exhaust valve is shown as 300. At step 310, the method may comprise advancing the timing of the exhaust valve.

At step 320, the at least one exhaust valve may be connected to a cam phaser. Advancing the timing of the exhaust valve comprises phasing the phaser.

At step 330, the at least one exhaust valve may be connected to a solenoid. Advancing the timing of the exhaust valve comprises activating the solenoid to adjust the opening and closing of the exhaust valve.

Another variation of a method of providing engine braking which includes an engine with multiple cylinders, each cylinder having blowdown exhaust valves and scavenging exhaust valves, the blowdown exhaust valve being actuatable by blowdown exhaust valve actuator and the scavenging exhaust valve being acuatable by a scavenging exhaust valve actuator and a controller connected to the actuators and configured to receive a braking signal is shown as 350 (FIG. 12b). At step 360, the method may comprise signaling one of blowdown exhaust valve actuator or the scavenging exhaust valve actuator to advance the timing of the associated blowdown or scavenging exhaust valve.

At step 370, one of the blowdown or scavenging exhaust valves is advanced 40-60 degrees.

A controller system may be provided and may in a main controller and/or a control subsystem may include one or more controllers (not separately shown) in communication with the actuator and sensors for receiving and processing sensor input and transmitting actuator output signals. The controller(s) may include one or more suitable processors and memory devices (not separately shown). The memory may be configured to provide storage of data and instructions that provide at least some of the functionality of the engine system and that may be executed by the processor(s). At least portions of the method may be enabled by one or more computer programs and various engine system data or instructions stored in memory as look-up tables, formulas, algorithms, maps, models, or the like. In any case, the control subsystem may control engine system parameters by receiving input signals from the sensors, executing instructions or algorithms in light of sensor input signals, and transmitting suitable output signals to the various actuators. As used herein, the term “model” may include any construct that represents something using variables, such as a look up table, map, formula, algorithm and/or the like. Models may be application specific and particular to the exact design and performance specifications of any given engine system.

Although the term “step” is used herein, such is not intended to limit the invention to the specific components, elements or acts described herein.

The following is a description of select number variations within the scope of the invention. The invention is not, however, limited to this description; and each variation and components, elements, and steps within each variation may be used alone or in combination with any of the other variations and components, elements, and steps within the other variations.

Variation 1 may include a product comprising an engine having at least one cylinder, the cylinder having at least one blowdown exhaust valve, at least one scavenging exhaust valve, and at least one intake valve. The engine further has a first actuator connected to the at least one blowdown exhaust valve and a second actuator connected to the scavenging exhaust valve. The product may also include a controller connected to one of the first or second actuator and adapted and configured to advance the timing of one of the blowdown or scavenging exhaust valves when the controller receives a braking signal.

Variation 2 may include the product of variation 1 wherein one of the first or second actuators is a variable camshaft phaser.

Variation 3 may include the product of variation 1 wherein the first actuator comprises a first camshaft and a first rocker arm and wherein the second actuator comprises a second camshaft and rocker arm.

Variation 4 may include the product of variation 1 wherein the intake valve is connected to one of the first or second actuators.

Variation 5 may include the product of variation 1 wherein the intake valve is connected to a third camshaft and rocker arm.

Variation 6 may include the product of variation 1 wherein one of the first or second actuators is a solenoid.

Variation 7 may include the product of variation 1 wherein both the first and second actuators are variable camshaft phasers.

Variation 8 may include a product for providing engine braking of an engine having at least one cylinder, the at least one cylinder having at least one exhaust valve connected to a variable valve timing mechanism. The product may comprise a controller connected to the variable valve timing mechanism and adapted and configured to advance the timing of the exhaust valve when the controller receives a braking signal.

Variation 9 may include a product of variation 8 wherein the variable valve timing mechanism is a variable camshaft phaser.

Variation 10 may include the product of variation 8 wherein the variable valve timing mechanism is a solenoid.

Variation 11 may include a method of generating engine braking for an engine having at least one cylinder with at least one exhaust valve, the method comprising advancing the timing of the exhaust valve.

Variation 12 may include the method of variation of claim 11 wherein the at least one exhaust valve is connected to a cam phaser and wherein advancing the timing of the exhaust valve comprises phasing the phaser.

Variation 13 may include the method of variation 11 wherein the at least one exhaust valve is connected to a solenoid and wherein advancing the timing of the exhaust valve comprises activating the solenoid to adjust the opening and closing of the exhaust valve.

Variation 14 may include a method of providing engine braking which includes an engine with multiple cylinders, each cylinder having blowdown exhaust valves and scavenging exhaust valves, the blowdown exhaust valve being actuatable by blowdown exhaust valve actuator and the scavenging exhaust valve being acuatable by a scavenging exhaust valve actuator and a controller connected to the actuators and configured to receive a braking signal. The method may comprise signaling one of blowdown exhaust valve actuator or the scavenging exhaust valve actuator to advance the timing of the associated blowdown or scavenging exhaust valve.

Variation 15 may include the method of variation 14 wherein one of the blowdown or scavenging exhaust valves is advanced 40-60 degrees.

The above description of variations of the invention is merely illustrative in nature and, thus, variations thereof are not to be regarded as a departure from the spirit and scope of the invention.

What is claimed is:

1. A product comprising:
an engine having at least one cylinder, the cylinder having at least one blowdown exhaust valve, at least one scavenging exhaust valve, and at least one intake valve, the engine further having a first actuator connected to the at least one blowdown exhaust valve and a second actuator connected to the scavenging exhaust valve and
a controller connected to one of the first or second actuator and adapted and configured to advance the timing of one of the blowdown or scavenging exhaust valves when the controller receives a braking signal.

2. A product as set forth in claim 1 wherein one of the first or second actuators is a variable camshaft phaser.

3. A product as set forth in claim 1 wherein the first actuator comprises a first camshaft and a first rocker arm and wherein the second actuator comprises a second camshaft and rocker arm.

4. A product as set forth in claim 1 wherein the intake valve is connected to one of the first or second actuators.

5. A product as set forth in claim 1 wherein the intake valve is connected to a third camshaft and rocker arm.

6. A product as set forth in claim 1 wherein one of the first or second actuators is a solenoid.

7. A product as set forth in claim 1 wherein both the first and second actuators are variable camshaft phasers.

8. A product for providing engine braking of an engine having at least one cylinder, the at least one cylinder having at least one exhaust valve connected to a variable valve timing mechanism, the product comprising:
a controller connected to the variable valve timing mechanism and adapted and configured to advance the timing of the exhaust valve when the controller receives a braking signal.

9. The product as set forth in claim 8 wherein the variable valve timing mechanism is a variable camshaft phaser.

10. The product as set forth in claim 8 wherein the variable valve timing mechanism is a solenoid.

11. A method of generating engine braking for an engine having at least one cylinder with at least one exhaust valve, the method comprising:
advancing the timing of the exhaust valve.

12. The method of claim 11 wherein the at least one exhaust valve is connected to a cam phaser and wherein advancing the timing of the exhaust valve comprises phasing the phaser.

13. The method of claim 11 wherein the at least one exhaust valve is connected to a solenoid and wherein advancing the timing of the exhaust valve comprises activating the solenoid to adjust the opening and closing of the exhaust valve.

14. A method of providing engine braking which includes an engine with multiple cylinders, each cylinder having blowdown exhaust valves and scavenging exhaust valves, the blowdown exhaust valve being actuatable by blowdown exhaust valve actuator and the scavenging exhaust valve being acuatable by a scavenging exhaust valve actuator and a controller connected to the actuators and configured to receive a braking signal, the method comprising:
signaling one of blowdown exhaust valve actuator or the scavenging exhaust valve actuator to advance the timing of the associated blowdown or scavenging exhaust valve.

15. The method of claim 12 wherein one of the blowdown or scavenging exhaust valves is advanced 40-60 degrees.
